(19) United States
(12) Patent Application Publication
(10) Pub. No.: US 2026/0274616 A1
(43) Pub. Date: Sep. 17, 2026

(54) ELEVATOR APPARATUS

(71) Applicant: Hitachi, Ltd., Tokyo (JP)

(72) Inventors: Yuki SAITO, Tokyo (JP); Hiroki MATSUURA, Tokyo (JP); Hiroyuki YAMAMOTO, Tokyo (JP)

(21) Appl. No.: 18/873,065

(22) PCT Filed: Jun. 29, 2022
(86) PCT No.: PCT/JP2022/025988

§ 371 Date: Dec. 9, 2024

(51) Int. Cl. B66B 5/18; B66B 5/06

(52) U.S. Cl. CPC B66B 5/18; B66B 5/06

(57) ABSTRACT

Disclosed is an elevator apparatus having a power outage operation function while including an emergency stop device actuated by an electric actuator. The elevator apparatus includes a car, an emergency stop device provided at the car, a drive mechanism configured to drive the emergency stop device, an electric actuator configured to actuate the drive mechanism, and a controller configured to control an operation of the car. The electric actuator includes a movable element mechanically connected to the drive mechanism, and an electromagnet facing the movable element. The elevator apparatus further includes a DC power supply connected to the electromagnet via a power supply contact and configured to excite the electromagnet, and a storage battery connected to the electromagnet. The controller cuts off the power supply contact during power outage, and the electromagnet is excited by the storage battery when the power supply contact is cut off.

### TECHNICAL FIELD

The present invention relates to an elevator apparatus including an emergency stop device that is actuated by an electric actuator.

### BACKGROUND ART

An elevator apparatus includes a governor and an emergency stop device to constantly monitor an elevating speed of a car and emergency-stop the car in a predetermined overspeed state. Generally, the car and the governor are coupled to each other by a governor rope. When the overspeed state is detected, the governor restricts the governor rope to operate the emergency stop device on a car side and emergency-stop the car.

In such an elevator apparatus, since the governor rope which is elongated is laid in a hoistway, it is difficult to save space and reduce cost. Further, when the governor rope swings, a structure in the hoistway is likely to interfere with the governor rope.

In view of this problem, an emergency stop device that is actuated electrically without using a governor rope is proposed. A technique related to such an emergency stop device in the related art is disclosed in PTL 1.

In the related art, a car is provided with a drive shaft that drives an emergency stop device, and an electric actuator that actuates the drive shaft. The electric actuator includes a movable iron core mechanically connected to the drive shaft, and an electromagnet that attracts the movable iron core. The drive shaft is biased by a drive spring, but during normal times, movement of the drive shaft is restricted by the electric actuator since the electromagnet is energized and the movable iron core is attracted.

In an emergency, the electromagnet is demagnetized to release the restriction on the drive shaft, and the drive shaft is driven by a biasing force of the drive spring. As a result, the emergency stop device is actuated to emergency-stop the car.

When the emergency stop device is returned to a normal state, the electromagnet is moved and brought close to the movable iron core that was moved in an emergency. The electromagnet includes a feed nut that is screwed onto a feed screw shaft. When the feed screw shaft is rotated by a motor, the electromagnet moves toward the movable iron core. When the electromagnet comes into contact with the movable iron core, the movable iron core is attracted to the electromagnet. In a state in which the movable iron core is attracted to the electromagnet, the electromagnet is further moved to return the movable iron core and the electromagnet to a normal standby position.

### CITATION LIST

### Patent Literature

PTL 1: JP2021-130550A

### SUMMARY OF INVENTION

### Technical Problem

In the related art described above, when a power supply to the electromagnet is lost due to a power outage, the electric actuator is actuated and the emergency stop device is actuated as in a case when an overspeed state is detected. Therefore, it is difficult to operate a car during a power outage or power restoration depending on a state of the electric actuator.

Therefore, the invention provides an elevator apparatus having a power outage operation function and including an emergency stop device actuated by an electric actuator.

### Solution to Problem

In order to solve the above problem, an elevator apparatus according to the invention includes a car, an emergency stop device provided at the car, a drive mechanism configured to drive the emergency stop device, an electric actuator configured to actuate the drive mechanism, and a controller configured to control an operation of the car. The electric actuator includes a movable element mechanically connected to the drive mechanism, and an electromagnet facing the movable element. The elevator apparatus further includes a DC power supply connected to the electromagnet via a power supply contact and configured to excite the electromagnet, and a storage battery connected to the electromagnet. The controller cuts off the power supply contact during power outage, and the electromagnet is excited by the storage battery when the power supply contact is cut off.

### Advantageous Effects of Invention

According to the invention, the elevator apparatus including the emergency stop device actuated by the electric actuator can have a power outage operation function.

Problems, configurations, and effects other than those described above will be clarified by the following description of embodiments.

### BRIEF DESCRIPTION OF DRAWINGS

FIG. 1 is a schematic configuration diagram showing an elevator apparatus according to an embodiment.

FIG. 2 is a plan view showing mechanical portions and electrical device portions of an electric actuator according to the present embodiment in an installed state shown in FIG. 1.

FIG. 3 is a flowchart showing a state diagnosis for a storage battery executed by an elevator controller according to the present embodiment.

FIG. 4 is a flowchart showing processing after the state diagnosis for the storage battery executed by the elevator controller according to the present embodiment.

### DESCRIPTION OF EMBODIMENTS

Hereinafter, an elevator apparatus according to an embodiment of the invention will be described with reference to the drawings. In the drawings, components having the same reference numerals indicate the same components or components having similar functions.

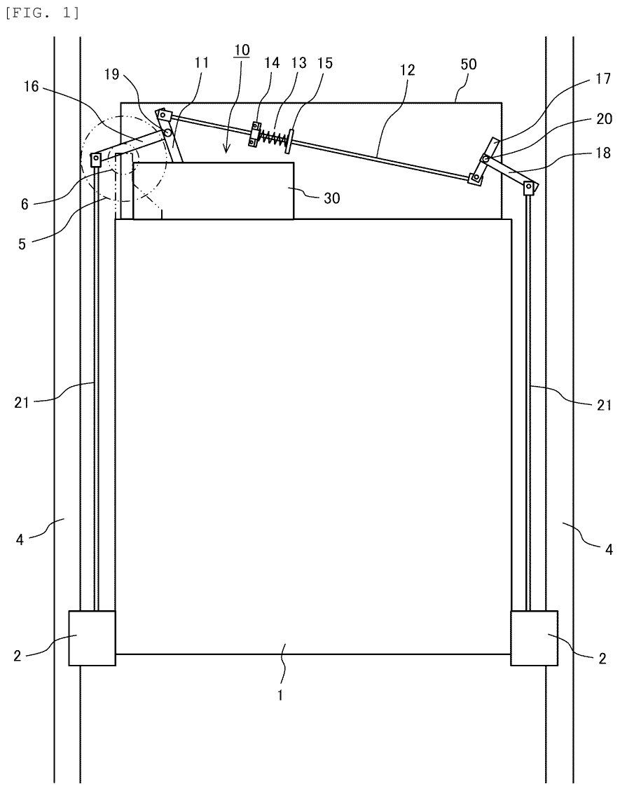

FIG. 1 is a schematic configuration diagram showing an elevator apparatus according to an embodiment of the invention.

As shown in FIG. 1, the elevator apparatus includes a car 1, speed sensors (5 and 6), an electric actuator 10, drive mechanisms (12 to 20), pull-up rods 21, and emergency stop devices 2.

The car 1 is suspended by a main rope (not shown) in a hoistway provided in a building, and is slidably engaged with guide rails 4 via guide devices. When the main rope is frictionally driven by a drive device (hoist: not shown), the car 1 is moved up and down in the hoistway.

The speed sensor in the present embodiment is provided on the car 1, and includes a rotary detector 6 and a roller 5 connected to a rotation shaft of the rotary detector 6. In the present embodiment, the roller 5 is connected to the rotation shaft of the rotary detector 6 such that a rotation shaft of the roller 5 and the rotation shaft of the rotary detector 6 are coaxial. For example, a rotary encoder can be applied as the rotary detector 6.

The roller 5 is in contact with the guide rail 4. Therefore, the roller 5 rotates when the car 1 moves up and down, and the rotary detector 6 rotates accordingly. A safety controller to be described later monitors a traveling speed of the car 1 based on a rotational position signal output by the rotary detector 6 accompanying the rotation.

An image sensor may be used as the speed sensor. In this case, a position and a speed of the car 1 are detected based on image information on a surface state of the guide rail 4 acquired by the image sensor. For example, the speed is calculated based on a movement distance of an image feature in a predetermined time.

In the present embodiment, the electric actuator 10 is an electromagnetic operation device and is disposed on an upper portion of the car 1. The electromagnetic operation device includes, for example, a movable piece or a movable rod actuated by a solenoid or an electromagnet. The electric actuator 10 is actuated when the speed sensors (5, 6) detect a predetermined overspeed state of the car 1. At this time, the pull-up rod 21 is pulled up by the drive mechanisms (12 to 20) that are mechanically connected to an operation lever 11. Accordingly, the emergency stop device 2 enters a braking state.

The drive mechanisms (12 to 20) will be described later.

One emergency stop device 2 is disposed on each of left and right sides of the car 1. A pair of braking elements (not shown) provided in each emergency stop device 2 are movable between a braking position and a non-braking position, and clamp the guide rails 4 in the braking position. When the emergency stop device 2 moves up relative to the car 1 due to the car 1 moving down, a braking force is generated by a frictional force acting between the braking elements and the guide rails 4. Accordingly, the emergency stop device 2 is actuated when the car 1 falls into an overspeed state, and emergency-stops the car 1.

The elevator apparatus in the present embodiment includes a so-called low-press governor system that does not use a governor rope. When an elevating speed of the car 1 exceeds a rated speed and reaches a first overspeed (for example, a speed that does not exceed a speed 1.3 times the rated speed), a power supply to the drive device (the hoist) and a power supply to a control device that controls the drive device are cut off. When a descending speed of the car 1 reaches a second overspeed (for example, a speed that does not exceed a speed 1.4 times the rated speed), the electric actuator 10 provided on the car 1 is electrically driven to actuate the emergency stop device 2 and emergency-stop the car 1.

In the present embodiment, the low-press governor system includes the speed sensors (5, 6) and the safety controller that determines an overspeed state of the car 1 based on an output signal of the speed sensors. The safety controller measures a speed of the car 1 based on the output signal of the speed sensors. When the safety controller determines that the measured speed reaches the first overspeed, the safety controller outputs a command signal for cutting off the power supply to the drive device (the hoist) and the power supply to the control device that controls the drive device. When the safety controller determines that the measured speed reaches the second overspeed, the safety controller outputs a command signal for actuating the electric actuator 10.

As described above, when the pair of braking elements provided in the emergency stop device 2 are pulled up by the pull-up rods 21, the pair of braking elements clamp the guide rail 4. The pull-up rod 21 is driven by the drive mechanisms (12 to 20) connected to the electric actuator 10.

Hereinafter, a configuration of the drive mechanisms will be described.

The operation lever 11 of the electric actuator 10 is coupled to a first actuating piece 16 to form a substantially T-shaped first link member. The operation lever 11 and the first actuating piece 16 respectively constitute a head portion and a foot portion of a T shape. The substantially T-shaped first link member is pivotably supported by a crosshead 50 via a first actuating shaft 19 at a coupling portion between the operation lever 11 and the first actuating piece 16. One of a pair of pull-up rods 21 (on a left side in the drawing) has an end portion connected to an end portion of the first actuating piece 16 that is the foot portion of the T shape and is located on a side opposite to the coupling portion between the operation lever 11 and the first actuating piece 16.

A connection piece 17 is coupled to a second actuating piece 18 to form a substantially T-shaped second link member. The connection piece 17 and the second actuating piece 18 respectively constitute a head portion and a foot portion of a T shape. The substantially T-shaped second link member is pivotably supported by the crosshead 50 via a second actuating shaft 20 at a coupling portion between the connection piece 17 and the second actuating piece 18. The other one of the pair of pull-up rods 21 (on a left side in the drawing) has an end portion connected to an end portion of the second actuating piece 18 that is the foot portion f the T shape and is located on a side opposite to the coupling portion between the connection piece 17 and the second actuating piece 18.

An end portion of the operation lever 11 that extends from inside to outside of a case 30 and one of two end portions of the connection piece 17 that is closer to an upper portion of the car 1 than the second actuating shaft 20 are respectively connected to one end (on the left side in the drawing) and the other end (on the right side in the drawing) of a drive shaft 12 lying transversely on the car 1. The drive shaft 12 slidably passes through a fixed portion 14 fixed to the crosshead 50. The drive shaft 12 passes through a pressing member 15, and the pressing member 15 is fixed to the drive shaft 12. The pressing member 15 is located on a side closer to the second link member (the connection piece 17 and the second actuating piece 18) than the fixed portion 14. A drive spring 13 that is an elastic body is located between the fixed portion 14 and the pressing member 15, and the drive shaft 12 is inserted through the drive spring 13.

When the electric actuator 10 is actuated, that is, when energization to an electromagnet is cut off in the present embodiment, an electromagnetic force that restricts movement of the operation lever 11 against a biasing force of the drive spring 13 disappears. Accordingly, the drive shaft 12 is driven along a longitudinal direction by the biasing force of the drive spring 13 applied to the pressing member 15. Therefore, the first link member (the operation lever 11 and the first actuating piece 16) pivots about the first actuating shaft 19, and the second link member (the connection piece 17 and the second actuating piece 18) pivots about the second actuating shaft 20. Accordingly, one of the pull-up rods 21 connected to the first actuating piece 16 of the first link member is driven and pulled up, and the other pull-up rod 21 connected to the second actuating piece 18 of the second link member is driven and pulled up at the same time.

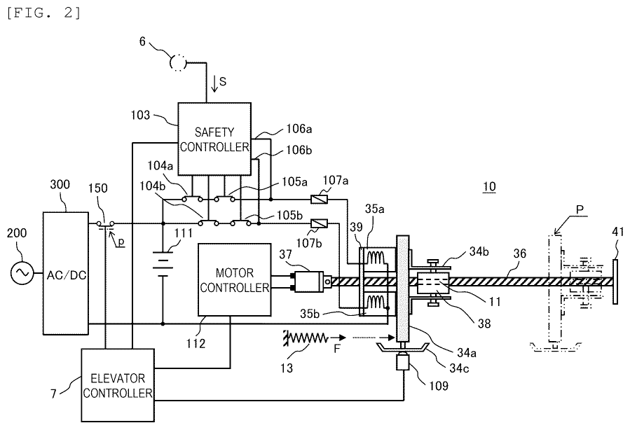

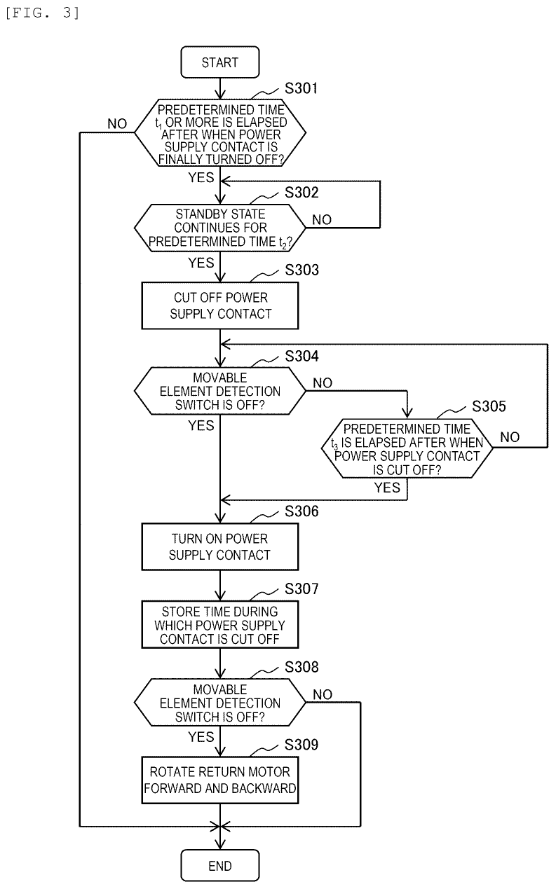

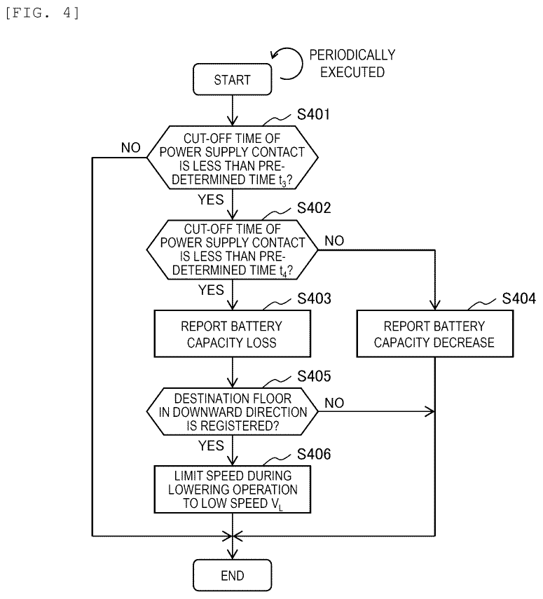

FIG. 2 is a plan view showing mechanical portions and electrical device portions of the electric actuator 10 according to the present embodiment in an installed state shown in FIG. 1. The electric actuator 10 shown in FIG. 2 is stored in the case 30 shown in FIG. 1 (the same applies to FIGS. 3 and 4).

FIG. 2 also shows a circuit configuration for controlling the electrical device portions (the same applies to FIGS. 3 and 4). In FIG. 2, the emergency stop devices 2 (FIG. 1) are in a non-braking state, and the electric actuator 10 is in a standby state. That is, the elevator apparatus is in a normal operation state.

As shown in FIG. 2, in the standby state, a movable element (34a, 34b, 34c) that is a movable member connected to the operation lever 11 is attracted by electromagnetic forces to electromagnets 35a and 35b whose coils are energized and excited. Accordingly, movement of the movable element is restricted against a biasing force F of the drive spring 13 (FIG. 1) acting on the movable element via the drive shaft 12 (FIG. 1) and the operation lever 11. Accordingly, the electric actuator 10 restricts movement of the drive mechanisms (12 to 20: FIG. 1) against the biasing force of the drive spring 13.

The movable element includes an attraction portion 34a that is attracted to pole surfaces of the electromagnets 35a and 35b and a support portion 34b that is fixed to the attraction portion 34a and to which the operation lever 11 is connected. The operation lever 11 is pivotably connected to the support portion 34b of the movable element via a connection bracket 38. The electric actuator 10 is provided with a movable element detection switch 109 at a position where the attraction portion 34a of the movable element is located during standby.

The movable element further includes a cam portion 34c fixed to the attraction portion 34a. When the movable element is located at a standby position, the movable element detection switch 109 is operated by the cam portion 34c. When the movable element detection switch 109 is operated by the cam portion 34c, the movable element detection switch 109 transitions from an on state to an off state or from the off state to the on state. Accordingly, it is possible to detect whether the movable element is located at the standby position according to a state of the movable element detection switch 109.

In the present embodiment, the movable element detection switch 109 is in the on state when the movable element detection switch 109 is operated by the cam portion 34c.

In the movable element (34a, 34b, 34c) according to the present embodiment, at least the attraction portion 34a is made of a magnetic material. A soft magnetic material such as low-carbon steel and permalloy (iron-nickel alloy) is preferably used as the magnetic material.

Other mechanism units (36, 37, 39, 41) shown in FIG. 2 will be described later.

The electromagnets 35a and 35b are excited by a DC power supply 300 and a storage battery 111. The DC power supply 300 includes a rectifier or a power converter that converts AC power input from a commercial AC power supply 200 into DC power. A DC output of the DC power supply 300 is connected in parallel to the storage battery 111 via a power supply contact 150. The power supply contact 150 is implemented by a contact provided in, for example, an electromagnetic relay, an electromagnetic contactor, and an electromagnetic switch.

When AC power is supplied from the commercial AC power supply 200, mainly the electromagnets 35a and 35b are excited by the DC power supply 300. At this time, an elevator controller 7 controls the power supply contact 150 to be in a closed state. Accordingly, the DC power supply 300 excites the electromagnets 35a and 35b and charges the storage battery 111.

When the commercial AC power supply 200 fails, the electromagnets 35a and 35b are excited by the storage battery 111. At this time, the elevator controller 7 controls the power supply contact 150 to be in an on state. Accordingly, a discharge current from the storage battery 111 is prevented from flowing to the DC power supply 300 side. As will be described later, the power supply contact 150 is also controlled by the elevator controller 7 when the elevator controller 7 executes a state diagnosis for the storage battery 111.

In an excitation circuit of the electromagnet 35a, one end of a coil of the electromagnet 35a is connected to a high potential side of the storage battery 111 via electrical contacts 104a and 105a and a fuse 107a that are connected in series, and is further connected to a high potential side of the DC output of the DC power supply 300 via the power supply contact 150. The other end of the coil of the electromagnet 35a is connected to a low potential side of the storage battery 111 and a low potential side of the DC power supply.

In an excitation circuit of the electromagnet 35b, one end of a coil of the electromagnet 35b is connected to a high potential side of the storage battery 111 via electrical contacts 104b and 105b and a fuse 107b that are connected in series, and is further connected to a high potential side of the DC output of the DC power supply 300 via the power supply contact 150. The other end of the coil of the electromagnet 35b is connected to a low potential side of the storage battery 111 and a low potential side of the DC power supply.

The fuses 107a, 107b are provided in the excitation circuits to protect the electromagnets 35a and 35b from an overcurrent.

The electrical contacts 104a, 105a, 104b, and 105b are controlled to be on and off by a safety controller 103. In the standby state of the electric actuator 10, the safety controller 103 controls the electrical contacts 104a, 105a, 104b, and 105b to be in an on state. Accordingly, when the coils of the electromagnets 35a and 35b are energized, the electromagnets 35a and 35b generate electromagnetic forces.

Each of the electrical contacts 104a, 105a, 104b, and 105b is implemented by a contact provided in, for example, an electromagnetic relay, an electromagnetic contactor, and an electromagnetic switch. In each of the excitation circuits of the electromagnets 35a and 35b, a plurality of (two in FIG. 2) electrical contacts are connected in series. Accordingly, even when an on failure occurs in one contact when the plurality of electrical contacts are controlled to be in an off state to actuate the emergency stop device 2 as will be described later, energization of the electromagnet is cut off. Accordingly, operation reliability of the electric actuator 10 is improved. The on failure occurs due to, for example, welding of a contact.

Other electrical device portions (37, 112) will be described later. Signal lines 106a and 106b are used to input answer back signals from the excitation circuits of the electromagnets 35a and 35b to the safety controller 103.

An answer back signal (hereinafter referred to as an “answer back signal (106a)”) input to the safety controller 103 via the signal line 106a indicates a potential of one of the two ends of the coil of the electromagnet 35a which is connected to the high potential side of the storage battery 111 and the high potential side of the DC power supply 300 via the electrical contacts 104a and 105a. Accordingly, the answer back signal (106a) indicates a potential (a high potential (HIGH) ) on the high potential side of the storage battery 111 and the high potential side of the DC power supply 300 when the electromagnet 35a is energized, and indicates a potential (a low potential (LOW) ) on the low potential side of the storage battery 111 and the low potential side of the DC power supply 300 when the electromagnet 35a is not energized. The safety controller 103 detects an energization state of the electromagnet 35a based on a potential indicated by the answer back signal (106a).

The answer back signal (hereinafter referred to as an “answer back signal (106b)”) input to the safety controller 103 via the signal line 106b indicates a potential of one of the two ends of the coil of the electromagnet 35b which is connected to the high potential side of the storage battery 111 and the high potential side of the DC power supply 300 via the electrical contacts 104b and 105b. Accordingly, the answer back signal (106b) indicates a potential (a high potential (HIGH) ) on the high potential side of the storage battery 111 and the DC power supply 300 when the electromagnet 35b is energized, and indicates a potential (a low potential (LOW) ) on the low potential side of the storage battery 111 and the low potential side of the DC power supply 300 when the electromagnet 35b is not energized. The safety controller 103 detects an energization state of the electromagnet 35b based on a potential indicated by the answer back signal (106b).

Next, an operation of the electric actuator 10 when the emergency stop device 2 is actuated will be described.

When the safety controller 103 detects a predetermined overspeed state (the above-described second overspeed) of the car 1 based on a rotational position signal from the rotary detector 6, the safety controller 103 outputs an off command to each of the electrical contacts 104a, 105a, 104b, and 105b. In response to the off command, the electrical contacts 104a, 105a, 104b, and 105b transition from an on state (FIG. 2) to an off state. Therefore, excitation of the electromagnets 35a and 35b is stopped, and thus electromagnetic forces acting on the movable element (34a, 34b, 34c) disappear. Accordingly, the restriction on the movable element by the attraction of the attraction portion 34a of the movable element to the electromagnets 35a and 35b is released, and thus the movable element is moved, by the biasing force (F shown in FIG. 2) of the drive spring 13, from a position (FIG. 2) in the standby state to a position P in a direction (a rightward direction in the drawing) of the biasing force of the drive spring 13. In FIG. 2, the moved movable element is indicated by a two-dot chain line.

As the restriction on the movable element is released, the drive shaft 12 is driven by the biasing force of the drive spring 13 (FIG. 1) acting on the pressing member 15 (FIG. 1) of the drive shaft 12 in a direction from the fixed portion 14 (FIG. 1) toward the pressing member (FIG. 1). When the drive shaft 12 is driven, the first link member (the operation lever 11 and the first actuating piece 16: FIG. 1) connected to the drive shaft 12 pivots about the first actuating shaft 19 (FIG. 1). Accordingly, the pull-up rod 21 (FIG. 1) connected to the first actuating piece 16 is pulled up. When the drive shaft 12 is driven, the second link member (the connection piece 17 and the second actuating piece 18: FIG. 1) connected to the drive shaft 12 pivots about the second actuating shaft 20 (FIG. 1). Accordingly, the pull-up rod 21 (FIG. 1) connected to the second actuating piece 18 is pulled up.

Next, a return operation of the electric actuator 10 will be described.

To return the electric actuator 10 to the standby state from an actuated state, as will be described later, the movable element (34a, 34b, 34c) is returned to a standby position from a moved position (the position P in FIG. 2) by the return mechanism units (36, 37, 39, and 41) and the electrical device portions (37 and 112).

The electric actuator 10 includes a feed screw 36 for driving the movable element. The feed screw 36 is coaxially connected to a rotation shaft of a motor 37 and is rotatably supported by a support member 41. The electromagnets 35a and 35b are fixed to an electromagnet support plate 39 including a feed nut portion (not shown). The feed nut portion of the electromagnet support plate 39 is screwed with the feed screw 36. The feed screw 36 is rotated by the motor 37. The motor 37 is driven by a motor controller 112.

The motor controller 112 includes a drive circuit for the motor 37, and controls rotation of the motor 37 according to a control command from the elevator controller 7. The motor 37 may be either a DC motor or an AC motor.

The elevator controller 7 controls a normal operation of the car 1 and has information on an operation state of the car 1. In the present embodiment, as described above, the elevator controller 7 further has a function of controlling the motor 37 provided in the electric actuator 10.

When the electric actuator 10 is returned to the standby state, the elevator controller 7 sends a rotation command for the motor 37 to the motor controller 112. Upon receiving the rotation command, the motor controller 112 drives the motor 37 to rotate the feed screw 36. The rotation of the motor 37 is converted into linear movement of the electromagnets 35a and 35b along an axial direction of the feed screw 36 by the rotating feed screw 36 and the feed nut portion of the electromagnet support plate 39. Accordingly, the electromagnets 35a and 35b approach the moved position P of the movable element (34a, 34b, 34c), and come into contact with the movable element.

The motor controller 112 monitors a motor current for controlling the motor 37. When the electromagnets 35a and 35b come into contact with the movable element as described above, a load of the motor 37 increases, and the motor current increases accordingly. When the motor current increases and exceeds a predetermined value, the motor controller 112 determines that the electromagnets 35a and 35b are in contact with the movable element. The motor controller 112 sends a determination result to the safety controller 103 and the elevator controller 7.

Upon receiving the determination result from the motor controller 112, the safety controller 103 outputs an on command to each of the electrical contacts 104a, 105a, 104b, and 105b. In response to the on command, the electrical contacts 104a, 105a, 104b, and 105b transition from an off state to an on state. Therefore, the electromagnets 35a and 35b are excited. The attraction portion 34a of the movable element is attracted to the electromagnets 35a and 35b by electromagnetic forces of the excited electromagnets 35a and 35b.

Upon receiving the determination result from the motor controller 112, the elevator controller 7 sends a reverse rotation command for the motor 37 to the motor controller 112. Upon receiving the reverse rotation command, the motor controller 112 reverses a rotation direction of the motor 37 and rotates the feed screw 36 in a reverse direction. Accordingly, the movable element attracted to the electromagnets 35a and 35b receives a biasing force of the drive spring 13, and moves toward the standby position together with the electromagnets 35a and 35b.

The cam portion 34c of the movable element (34a, 34b, 34c) is separated from the movable element detection switch 109 from when the electric actuator 10 is actuated and the movable element (34a, 34b, 34c) is moved to the position P (FIG. 3) up to immediately before the completion of the return operation of the electric actuator 10. Accordingly, the movable element detection switch 109 is in an off state at this time.

When the movable element (34a, 34b, 34c) attracted to the electromagnets 35a, 35b reaches the standby position, the movable element detection switch 109 is operated by the cam portion 34c of the movable element. When the movable element detection switch 109 is operated, the elevator controller 7 determines that the movable element is located at the standby position.: The elevator controller 7 sends a stop command for the motor 37 to the motor controller 112 based on this determination result. Upon receiving the stop command, the motor controller 112 stops the rotation of the motor 37.

As will be described later, the state diagnosis for the storage battery 111 is executed by the elevator controller 7 when the elevator apparatus is in operation, when no call is registered, and when the car 1 is in a standby state where the car 1 is stopped at the first floor. The elevator controller 7 sets the power supply contact 150 to be in an on state, stops the excitation of the electromagnets 35a and 35b by the DC power supply 300, and excites the electromagnets 35a and 35b by the storage battery 111. The elevator controller 7 diagnoses the storage battery 111 as normal when the excitation by the storage battery 111 continues for a predetermined time. At this time, the elevator controller 7 diagnoses the storage battery 111 as normal when the elevator controller 7 determines that the movable element continues to be attracted to the electromagnets 35a and 35b for a predetermined time and the movable element detection switch 109 is maintained in the on state.

FIG. 3 is a flowchart showing a state diagnosis for the storage battery 111 executed by the elevator controller 7 according to the present embodiment.

When the processing is started, first, the elevator controller 7 determines in step S301 that whether a predetermined time t₁ or more is elapsed after when the power supply contact 150 is finally turned off (FIG. 2). t₁ can be freely set in consideration of an interval between diagnoses of other elevator apparatuses or the like. For example, t₁ is set to 30 days.

When a call is not registered and the car 1 is stopped, that is, when the car 1 is in the standby state, the elevator controller 7 executes step S301.

When the elevator controller 7 determines that t₁ or more is elapsed (YES in step S301), next the elevator controller 7 executes step 302, and when the elevator controller 7 determines that t₁ or more is not elapsed (NO in step 301), the elevator controller 7 ends a series of processing.

In step S302, the elevator controller 7 determines whether the standby state continues for a predetermined time t₂. t₂ is freely set in consideration of a standby state continuing time that can be estimated to be an elevator usage situation in which service is not lowered even when the state diagnosis for the storage battery 111 is executed. For example, t₂ is set to 10 minutes.

When the elevator controller 7 determines that the standby state continues for t₂ or more (YES in step S302), next the elevator controller 7 executes step S303, and when the elevator controller 7 determines that the standby state does not continue for t₂ or more (NO in step S302), the elevator controller 7 executes step S302 again.

In step S303, the elevator controller 7 cuts off the power supply contact 150. Accordingly, the electromagnets 35a and 35b of the electric actuator 10 are electrically cut off from the DC power supply 300, and are excited by the storage battery 111 only. That is, an excited state of the electromagnets 35a and 35b during power outage is simulated. After step S303, the elevator controller 7 executes step S304.

In step S304, the elevator controller 7 determines whether the movable element detection switch 109 (FIG. 2) is in an off state. The off state of the movable element detection switch 109 indicates that the movable element (34a, 34b, 34c) (FIG. 2) cannot be held at the standby position by the excitation of the electromagnets 35a and 35b by the storage battery 111, and the movable element is moved to the position P shown in FIG. 2.

When the elevator controller 7 determines that the movable element detection switch 109 is in the off state (YES in step S304), next the elevator controller 7 executes step S306, and when the elevator controller 7 determines that the movable element detection switch 109 is not in the off state (NO in step S304), that is, when the elevator controller 7 determines that the movable element detection switch 109 is in an on state, the elevator controller 7 measures an elapsed time (initial value=0) after a time point when the power supply contact 150 is cut off (step 303), and next the elevator controller 7 executes step S305.

In step S305, the elevator controller 7 determines, based on the measured value of the elapsed time, whether a predetermined time t₃ is elapsed after when the power supply contact 150 is cut off. The predetermined time t₃ is set in consideration of a time during which the storage battery 111 is required to be able to supply power to the electromagnets 35a and 35b during power outage. The time during which power can be supplied is, for example, a time up to when the car is stopped if power outage occurs while the car is traveling at highest speed. For example, t₃ is set to 3 minutes.

When the elevator controller 7 determines that the predetermined time t₃ is elapsed (YES in step S305), next the elevator controller 7 executes step S306, and when the elevator controller 7 determines that the predetermined time t₃ is not elapsed (NO in step S305), the elevator controller 7 executes step S304 again.

In step S306, the elevator controller 7 turns on the power supply contact 150. Accordingly, the electromagnets 35a and 35b are excited by the DC power supply 300 regardless of a state of the storage battery 111. After step S306, the elevator controller 7 executes step S307.

In step S307, the elevator controller 7 stores a time during which the power supply contact 150 is cut off (hereinafter referred to as “cut-off time (t)”). As described above, in step S304, when the elevator controller 7 determines that the movable element detection switch 109 is not in the off state (NO in step S304), that is, when the elevator controller 7 determines that the movable element detection switch 109 is in the on state, the elevator controller 7 measures the elapsed time (initial value=0) after the time point when the power supply contact 150 is cut off (step S303). The measured value of the elapsed time is stored as the cut-off time (t).

After step S307, the elevator controller 7 executes step S308.

In step S308, the elevator controller 7 determines whether the movable element detection switch 109 is in an off state. When the elevator controller 7 determines that the movable element detection switch 109 is in the off state (YES in step S308), next, the elevator controller 7 executes step S309.

In step S309, the elevator controller 7 drives the motor 37 provided in the electric actuator 10 to move the electromagnets 35a and 35b, causes the electromagnets 35a and 35b to attract the movable element, and instructs the motor controller 112 to rotate the motor 37 forward and backward so as to return the movable element to the standby position. After step S309, the elevator controller 7 ends the series of processing.

When the elevator controller 7 determines in step S308 that the movable element detection switch 109 is not in the off state (NO in step S308), that is, when the elevator controller 7 determines that the movable element detection switch 109 is in an on state, since the movable element is positioned at the standby position, the elevator controller 7 skips step S309, and ends the series of processing.

FIG. 4 is a flowchart showing processing after the state diagnosis for the storage battery 111 executed by the elevator controller according to the present embodiment.

In step S401, the elevator controller 7 determines whether the cut-off time (t) of the power supply contact 150 is less than the predetermined time t₃. When the elevator controller 7 determines that the cut-off time (t) is less than the predetermined time t₃ (YES in step S401), next the elevator controller 7 executes step S402, and when the elevator controller 7 determines that the cut-off time (t) is not less than the predetermined time t₃ (NO in step S401), the elevator controller 7 ends a series of processing since the storage battery 111 is in a normal state.

In step S402, the elevator controller 7 determines whether the cut-off time (t) of the power supply contact 150 is less than a predetermined time t₄. Here, the predetermined time t₄ is shorter than t₃. For example, t₃ is set to 3 minutes, and t₂ is set to 5 seconds. In order to distinguish a level of an abnormal state of the storage battery 111, t₃ and t₄ are set.

When the elevator controller 7 determines that the cut-off time is less than the predetermined time t₄ (YES in step S402), next the elevator controller 7 executes step S403, and when the elevator controller 7 determines that the cut-off time is not less than the predetermined time t₄ (NO in step S402), next the elevator controller 7 executes step S404.

In step S403, since the cut-off time is less than t₄, the elevator controller 7 determines that a battery capacity is lost, and reports the battery capacity loss to an external party such as a maintenance engineer and a maintenance company. After step S403, the elevator controller 7 executes step S405.

In step S404, since the cut-off time (t) is not less than t₄ but is relatively short as less than t₃ (t₄≤t<t₃), the elevator controller 7 determines that the battery capacity decreases, and reports the decrease in the battery capacity to an external party such as a maintenance engineer or a maintenance company. After step S404, the elevator controller 7 ends the series of processing.

In step S405, the elevator controller 7 determines whether a destination floor in a downward direction from a current position of the car is registered. When the elevator controller 7 determines that the destination floor is registered (YES in step S405), next the elevator controller 7 executes step S406, and when the elevator controller 7 determines that the destination floor is not registered (NO in step S405), the elevator controller 7 ends the series of processing.

In step S406, the elevator controller 7 limits a speed of the car during a lowering operation to a low speed V_{L}. V_{L} is set to be lower than a rated speed, and is set to, for example, 60 m/min.

After step S406, the elevator controller 7 ends the series of processing.

According to the present embodiment described above, the elevator apparatus including the emergency stop device 2 that is actuated by the electric actuator 10 can have a power outage operation function. Further, maintenance work can be performed quickly and accurately by providing a state diagnosis function for the storage battery 111 that supplies electric power to the electric actuator 10 during power outage. Accordingly, reliability of the power outage operation function of the electric actuator can be maintained.

According to the embodiment described above, the state diagnosis for the storage battery 111 is executed by the elevator controller 7 by cutting off the power supply contact 150 and setting the power supply contact 150 to an on state, stopping the excitation of the electromagnets 35a and 35b by the DC power supply 300, and exciting the electromagnets 35a and 35b by the storage battery 111. The elevator controller 7 diagnoses the storage battery 111 as normal when the excitation by the storage battery 111 continues for a predetermined time. At this time, the elevator controller 7 diagnoses the storage battery 111 as normal when the elevator controller 7 determines that the movable element continues to be attracted to the electromagnets 35a and 35b for a predetermined time and the movable element detection switch 109 is maintained in the on state.

As described above, similar to the case of power outage, electric power is supplied from the storage battery 111 to the electric actuator 10, and the electric actuator is maintained in the standby state in the present embodiment. That is, a position of the movable element of the electric actuator is held at the standby position. A state of the storage battery 111 is diagnosed according to a time during which the movable element can be held. Accordingly, according to the present embodiment, it is possible to diagnose with high accuracy whether the storage battery 111 is maintained in an appropriate state by the power outage operation function of the electric actuator 10.

Further, the elevator controller 7 executes the diagnosis by determining a diagnosis execution time and controlling the electric actuator and the power supply contact in the same manner as in the case of power outage. When the elevator apparatus is in operation, the state of the storage battery 111 can be automatically diagnosed without an operation performed by a maintenance engineer.

The invention is not limited to the above-described embodiment, and includes various modifications. For example, the embodiment described above is described in detail to facilitate understanding of the invention, and the invention is not necessarily limited to those including all configurations described above. One configuration in the embodiment can be added to, deleted from, or replaced with another configuration.

For example, instead of the movable element detection switch 109, another position detection sensor such as a photoelectric position sensor, a magnetic position sensor, and a proximity sensor (capacitive or inductive) may be applied.

The electric actuator 10 may be provided at a lower portion or a side portion of the car 1, in addition to an upper portion.

The elevator apparatus may further include a machine room or may be a so-called machine room-less elevator having no machine room.

### REFERENCE SIGNS LIST

1: car
2: emergency stop device
4: guide rail
5: roller
6: rotary detector
7: elevator controller
10: electric actuator
11: operation lever
12: drive shaft
13: drive spring
14: fixed portion
15: pressing member
16: first actuating piece
17: connection piece
18: second actuating piece
19: first actuating shaft
20: second actuating shaft
21: pull-up rod
30: case
34a: attraction portion
34b: support portion
34c: cam portion
35a, 35b: electromagnet
36: feed screw
37: motor
38: connection bracket
39: electromagnet support plate
41: support member
50: crosshead
103: safety controller
104a, 105a, 104b, 105b: electrical contact
106a, 106b: signal line
107a, 107b: fuse
109: movable element detection switch
111: storage battery
112: motor controller
150: power supply contact
200: commercial AC power supply
300: DC power supply

1. An elevator apparatus comprising:
a car;
an emergency stop device provided at the car;
a drive mechanism configured to drive the emergency stop device;
an electric actuator configured to actuate the drive mechanism; and
a controller configured to control an operation of the car, wherein
the electric actuator includes
a movable element mechanically connected to the drive mechanism, and
an electromagnet facing the movable element,
the elevator apparatus further comprising:
a DC power supply connected to the electromagnet via a power supply contact and configured to excite the electromagnet; and
a storage battery connected to the electromagnet,
the controller cuts off the power supply contact during power outage, and the electromagnet is excited by the storage battery when the power supply contact is cut off.

2. The elevator apparatus according to claim 1, wherein
when the controller diagnoses a state of the storage battery, the controller cuts off the power supply contact, measures a time during which a position of the movable element is held at a standby position, and diagnoses the state of the storage battery based on the measured time.

3. The elevator apparatus according to claim 2, wherein
the electric actuator includes a position detector configured to detect the movable element located at the standby position, and
the controller measures a time during which the position detector detects the movable element after the power supply contact is cut off, thereby measuring a time during which the position of the movable element is held at the standby position.

4. The elevator apparatus according to claim 2, wherein
the controller turns on the power supply contact after measuring the time during which the position of the movable element is held at the standby position, and
the electromagnet is excited by the DC power supply.

5. The elevator apparatus according to claim 3, wherein
the electric actuator includes a return mechanism configured to return, to the standby position, the movable element that was moved from the standby position,
the controller turns on the power supply contact after measuring the time during which the position of the movable element is held at the standby position,
the electromagnet is excited by the DC power supply, and
the return mechanism returns the movable element to the standby position when the position detector does not detect the movable element.

6. The elevator apparatus according to claim 1, wherein
the controller determines a time for diagnosing a state of the storage battery, and diagnoses the state of the storage battery in a standby state of the car after the time is determined.

7. The elevator apparatus according to claim 1, wherein
when the controller determines that a diagnosed state of the power storage battery is a capacity loss state, the controller sets a speed of the car during a lowering operation to a speed lower than a rated speed.
